(19) United States
(12) Patent Application Publication
(10) Pub. No.: US 2026/0146304 A1
(43) Pub. Date: May 28, 2026

(54) METHOD FOR RECOVERING RARE EARTH ELEMENTS FROM RARE EARTH RAW MATERIALS INCLUDING RARE EARTH ELEMENTS

(71) Applicant: KOREA INSTITUTE OF GEOSCIENCE AND MINERAL RESOURCES, Daejeon (KR)

(72) Inventors: Rina KIM, Daejeon (KR); Seo Jin HEO, Daejeon (KR); Ho Sung YOON, Seoul (KR); Chul Joo KIM, Daejeon (KR); Kyeong Woo CHUNG, Daejeon (KR); Sujeong LEE, Daejeon (KR)

(21) Appl. No.: 19/078,700

(22) Filed: Mar. 13, 2025

(30) Foreign Application Priority Data
Nov. 22, 2024 (KR) 10-2024-0168410

(51) Int. Cl. C22B 59/00; C22B 1/02; C22B 1/11; C22B 3/16; H01F 1/057

(52) U.S. Cl. CPC C22B 59/00; C22B 1/02; C22B 1/11; C22B 3/1658; H01F 1/0571

(57) ABSTRACT

The present disclosure relates to a method for recovering rare earth elements from rare earth raw materials, the method including steps of: alkali-treating a mixture of a reducing agent including a reductive metal having a lower standard reduction potential than goethite and the rare earth raw materials; and leaching the rare earth elements from the alkali-treated mixture using a deep eutectic solvent, wherein the rare earth raw materials include 10% by weight or more of goethite.

### CROSS-REFERENCE TO RELATED APPLICATION

This application claims the benefit of and priority to Korean Patent Application No. 10-2024-0168410, filed on Nov. 22, 2024, the entire disclosure(s) of which is hereby incorporated herein by reference in its entirety.

### BACKGROUND

### Field

The present disclosure relates to a method for recovering rare earth elements from rare earth raw materials including the rare earth elements.

### Description of Related Art

A conventional method for separating and recovering rare earth elements from rare earth tailings varies depending on the type, and in the case of monazite, where rare earth elements exist as phosphate minerals, a pretreatment process is conducted to convert rare earth phosphates, which are insoluble in acid, into extractable forms. This pretreatment process is largely divided into acid decomposition and alkali decomposition methods.

In the acid decomposition method, sulfuric acid is mainly used, and rare earth elements are recovered through water leaching after roasting the mixture of sulfuric acid and monazite at a high temperature of 200° C. or higher. However, the recovery of rare earth elements through the acid decomposition method has a disadvantage in those impurities other than rare earth elements are leached together, making the subsequent separation and purification process complicated.

The alkali decomposition method is divided into dry and wet methods, the dry method includes removing phosphates by mixing NaOH or Na₂CO₃ and roasting the mixture, and the wet method includes reacting with NaOH solution to convert rare earth phosphates into rare earth hydroxides, and then leaching rare earth elements with an inorganic acid solution. However, such an alkali decomposition technology is a method applied to monazite concentrate with low iron content, and when applied to rare earth tailings in which a large amount of iron oxide exists, there is a disadvantage in that selective leaching of rare earth elements is not easy when using inorganic acid since iron oxide is formed during the alkali treatment process.

### RELATED ART DOCUMENT

### Patent Document

Korean Patent No. 10-2528700 (Announcement Date: 2023, May 4)

### SUMMARY

An object of the present disclosure is to provide a method for recovering rare earth elements from rare earth raw materials including the rare earth elements.

The above object of the present disclosure is achieved by a method for recovering rare earth elements from rare earth raw materials, the method including steps of: alkali-treating a mixture of a reducing agent including a reductive metal having a lower standard reduction potential than goethite and the rare earth raw materials; and leaching the rare earth elements from the alkali-treated mixture using a deep eutectic solvent (DES), wherein the rare earth raw materials include 10% by weight or more of goethite.

The rare earth raw materials include rare earth tailings, wherein, in the rare earth tailings, the rare earth elements are contained in a phosphate mineral, and at least a portion of the phosphate mineral may be subjected to dephosphorylation by the alkali treatment.

The phosphate mineral includes at least one of monazite and florencite, and at least a portion of goethite may be reduced by the alkali treatment.

The alkali treatment is performed in a wet manner, and the leaching may be performed on the material obtained from the alkali treatment.

The reductive metal includes at least one of magnesium, iron, and aluminum, and the reducing agent may be used in an amount of 1 to 20 equivalents based on the content of goethite in the rare earth tailings.

The reducing agent may include a permanent magnet powder.

The reducing agent includes a NdFeB permanent magnet powder, and the reducing agent may be used in an amount of 3 to 10 equivalents based on the content of goethite in the rare earth tailings.

The rare earth element may include one of cerium, samarium, lanthanum, neodymium, praseodymium, and dysprosium.

The alkali treatment may be performed using NaOH.

The DES may be a DES of ethylene glycol and maleic acid.

In the rare earth tailings, total rare earth oxides (TREO) may be contained in an amount of 5 to 20% by weight and goethite may be contained in an amount of 30 to 80% by weight, the alkali treatment may be performed at 100 to 160° C. for 1 to 10 hours at a solid-liquid ratio of 1:5 to 1:20 (w/v) using a NaOH aqueous solution having a concentration of 20 to 70% or 40 to 60%, the leaching may be performed at 50 to 85° C. for 1 to 24 hours at a solid-liquid ratio of 1:100 to 50:100 (w/w), and the reducing agent may be used in an amount of 5 to 7 equivalents based on the content of goethite in the rare earth tailings.

According to the present disclosure, a method for recovering rare earth elements from rare earth raw materials including the rare earth elements is provided.

### BRIEF DESCRIPTION OF THE DRAWING

FIG. 1 is a flowchart of a method for recovering rare earth elements according to one embodiment of the present disclosure,

FIG. 2 shows an XRD pattern after NaOH roasting in Experimental Example 1,

FIG. 3 shows an XRD pattern after NaOH digestion in Experimental Example 3,

FIG. 4 shows XRD patterns after NaOH digestion according to the amounts of NdFeB used in Experimental Example 4,

FIG. 5 shows leaching efficiencies according to the amounts of NdFeB used in Experimental Example 4.

### DETAILED DESCRIPTION

Since a DES has intrinsic leaching characteristics for metal oxides depending on its type, rare earth elements can be separated from iron by selective leaching, using a DES in which iron oxide is insoluble as a leaching agent. However, in order to selectively separate the iron component from the rare earth leaching using the DES, the iron component must present as a divalent or trivalent iron oxide form, otherwise selective leaching can be interfered since goethite (FeOOH) included in the rare earth tailings is converted to a trivalent iron hydroxide (Fe(OH)₃) during the alkali pretreatment process. This is because in the case of trivalent iron (Fe³⁺), it is converted to NaFeO₂ during the NaOH digestion, and then to Fe(OH)₃ in the following washing process, unlike the metal iron (Fe) and divalent iron (Fe²⁺), which are converted to magnetite (Fe₃O₄) after the NaOH digestion. Therefore, for the selective leaching of rare earth elements, a pretreatment process of converting goethite in the rare earth tailings into divalent or trivalent iron oxide is required.

The present disclosure aims to provide a method for maximizing the selectivity and leaching efficiency of rare earth elements through rare earth leaching using a DES after a pretreatment process of NaOH digestion of the rare earth tailings by adding a reducing agent that can reduce goethite contained in the rare earth tailings.

The present disclosure will be described in more detail with reference to the drawings below.

If there is no separate mention in the following description, % means % by weight.

Since the accompanying drawings are only examples shown in order to explain the technical ideas of the present disclosure more specifically, the idea of the present disclosure is not limited to the accompanying drawings.

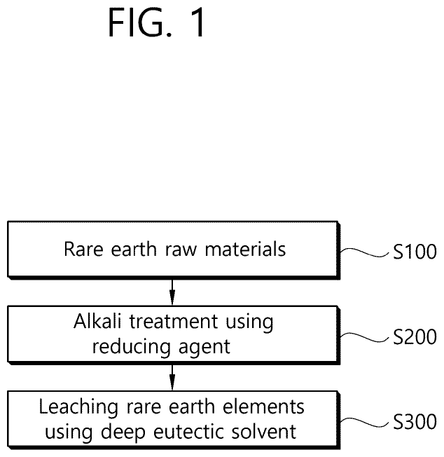

Referring to FIG. 1, a method for recovering rare earth elements according to one embodiment of the present disclosure will be described.

First, rare earth raw materials are prepared (S100).

Rare earth raw materials may be rare earth tailings and waste magnets, but are not limited thereto. Hereinafter, rare earth raw materials will be described as an example of rare earth tailings.

In the rare earth tailings, the content of the TREO may be 5 to 20% by weight or 6 to 15% by weight.

The rare earth element contained in the rare earth tailings may include any one of cerium, samarium, lanthanum, neodymium, praseodymium, and dysprosium.

The rare earth tailings may include goethite (FeOOH) in an amount of 10% by weight to 90% by weight, 10% by weight to 80% by weight, 10% by weight to 70% by weight, 30% by weight to 90% by weight, 30% by weight to 80% by weight, 50% by weight to 80% by weight, or 60% by weight to 80% by weight.

In rare earth tailings, rare earth elements may be included in phosphate minerals. Phosphate minerals may include any one of monazite and florencite.

In the rare earth tailings, monazite and florencite may be contained in an amount of 3 to 20% by weight or 6 to 12% by weight, respectively.

The rare earth tailings may include quartz, hematite, ilmenite, chlorite, etc. in addition to goethite and phosphate minerals.

Next, the rare earth tailings are alkali-treated using a reducing agent. Alkali treatment is aimed at a mixture of reducing agent and rare earth tailings.

The reducing agent includes a reductive metal with a lower standard reduction potential than goethite. The reductive metal may include at least one of magnesium, iron, and aluminum. Specifically, the reducing agent may be an iron powder or permanent magnet powder, and the permanent magnet powder may include an NdFeB permanent magnet powder.

The reducing agent may be used in an amount of 1 to 20 equivalents, 3 to 10 equivalents, or 5 to 7 equivalents with respect to the content of goethite in the rare earth tailings.

Alkali treatment may consist of dry treatment or wet treatment, and may use NaOH, Na₂CO₃, Ca(OH)₂, and NH₄OH, but is not limited thereto.

In the dry treatment, the NaOH beads and the rare earth tailings may be mixed at a mass ratio of 2:1 to 1:2, and then roasted at 400 to 600° C. for 1 hour to 5 hours.

The wet treatment (alkali digestion or NaOH digestion) may be performed at 100 to 160° C. for 1 to 10 hours at a solid-liquid ratio of 1:5 to 1:20 (w/v) or 1:8 to 1:15 (w/v) using 20 to 70% or 40 to 60% concentration of an NaOH aqueous solution.

During the alkali treatment process, dephosphorylation of phosphate minerals is performed and at least a portion of goethite is reduced.

Thereafter, rare earth elements are leached from the alkali-treated mixture using a DES (S300).

In the case of wet alkali treatment, leaching is performed for the digested material obtained from the alkali treatment. In addition, the leaching may be performed after washing the digested material (until the pH of the washing water became neutral).

In the case of dry alkali treatment, leaching is performed after the roasted mixture is washed with water.

The DES is a mixture of hydrogen bond acceptor (HBA) and hydrogen bond donor (HBD), wherein the HBA may be selected from the group consisting of choline chloride, ethylene glycol, N-ethyl-2-hydroxy-N,N-dimethylethanaminium chloride, 2-(chlorocarbonyloxy)-N,N,N-trimethylethanaminium chloride, N-benzil-2-hydroxy-N,N-dimethylethanaminium, 1-aminoguanidine hydrochloride, 1,3-diaminoguanidine hydrochloride, methanol, betaine hydrochloride, benzylcholine chloride, tetrabutylammonium chloride, glycerol, 1,2-propandiol, and 1,4-butanediol, and the HBD may be selected from the group consisting of lactic acid, maleic acid, urea, acetamide, 1-methylurea, 1,3-dimethylurea, 1,1-dimethylurea, thiourea, benzamide, glycerol, ethylene glycol, malonic acid, benzoic acid, adipic acid, oxalic acid, succinic acid, citric acid, malic acid, glycolic acid, proline, glucose, p-toluenesulfonic acid, tartaric acid, fructose, phenol, menthol, decanoic acid, ibuprofen, lidocaine, and sucrose.

Although it is not limited thereto, the DES may be a DES of ethylene glycol and maleic acid. The leaching may be performed at 50 to 85° C. for 1 hour to 24 hours at a solid-liquid ratio of 1:100 to 50:100 (w/w) or 5:100 to 15:100 (w/w).

The rare earth elements are selectively leached by the leaching using a DES.

Hereinafter, the present disclosure will be described in detail through Experimental Examples.

### Analysis of Rare Earth Tailings

The rare earth tailings, which are subject to the experiment, are flotation process tailings of rare earth ore based on carbonatite.

As a result of the content analysis of the rare earth tailings, the rare earth content was 8 wt. %, and TREO was 9.6 wt. %. Table 1 shows analysis results of the chemical compositions of the rare earth tailings (analyzed by ICP-MS and ICP OES).

TABLE 1

| Elements | Sc | Y | La | Ce | Pr | Nd | Sm | |
|---|---|---|---|---|---|---|---|---|
| Contents (wt. %) | 0.0136 | 0.066 | 1.89 | 3.94 | 0.3509 | 1.39 | 0.184 | Total |
| | | | | | | | | (wt. %) |

| Elements | Gd | Dy | Lu | Si | Al | P | Fe | |
|---|---|---|---|---|---|---|---|---|
| Contents (wt. %) | 0.125 | 0.0256 | 0.00038 | 5.67 | 9.11 | 1.99 | 36.9 | 61.7 |

As shown in Table 2, which is a quantitative X-ray diffraction (QXRD) analysis result of the rare earth tailings, the rare earth minerals in the tailings consist of monazite and florencite, and mostly consist of goethite (FeOOH) in addition to them.

TABLE 2

| Goethite | Florencite | Monazite | Quartz | Hematite | Ilmenite | Chlorite |
|---|---|---|---|---|---|---|
| 68 | 9 | 9 | 2 | 6 | 3 | 2 |

Both monazite and florencite are phosphate minerals, and rare earth elements exist as REPO₄ and REAl₃(PO₄)₂(OH)₆, respectively.

### Experimental Example 1—NaOH Alkali Treatment (Dry)

In order to selectively leach rare earth elements from tailings using DES that are effective for rare earth oxide leaching, a pretreatment process for dephosphorylation should be preceded.

Dry alkali treatment using NaOH was performed in order to perform dephosphorylation of tailings.

NaOH beads and a tailing sample were mixed at a mass ratio of 1:1 and then roasted at 500° C. for 2 hours. After that, the sample was washed until the pH of the washing water became neutral, dried, and leached at 70° C. for 7 hours in ethylene glycol (EG)-maleic acid (MA) DES, which is effective for light rare earth leaching, at a solid-liquid ratio of 5:100 (w/w).

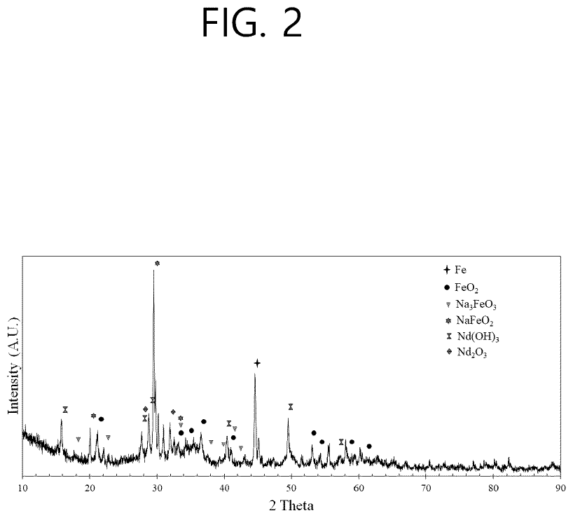

The XRD pattern after NaOH roasting is as shown in FIG. 2, and the leaching efficiency after the corresponding pretreatment is as shown in Table 3.

TABLE 3

| Fe (%) | Ce (%) | La (%) | Nd (%) | Pr (%) |
|---|---|---|---|---|
| 13.2 | 2.4 | 46.7 | 37.1 | 9.7 |

As a result of leaching, the leaching efficiency of rare earth elements was low, and the iron leaching efficiency was 13%, which was different from the usual experimental results in which iron oxide was insoluble in EG-MA DES.

### Experimental Example 2—NaOH Alkali Treatment (Wet)

NaOH digestion, a wet treatment, was applied in order to perform dephosphorylation of tailings.

After adding the tailing sample to a 50% NaOH aqueous solution at a solid-liquid ratio of 1:10 (w/v), it was reacted at 145° C. for 5 hours to perform the NaOH digestion. After that, the sample was washed until the pH of the washing water became neutral, and then roasted in a muffle furnace at 450° C. for 3 hours in order to convert iron hydroxide to iron oxide.

As a result of analyzing the XRD pattern of the NaOH digested product, the crystal structure of iron oxide was not observed. As a result of leaching the NaOH digestion-roasted sample at 70° C. for 5 hours in EG-MA DES at a solid-liquid ratio of 5:100 (w/w), although the leaching efficiency and selectivity were improved compared to those of the NaOH roasted product, they were still low as shown in Table 4.

TABLE 4

| Fe (%) | Ce (%) | La (%) | Nd (%) | Pr (%) |
|---|---|---|---|---|
| 6.66 | 1.4 | 71.9 | 55.7 | 17.7 |

A large amount of goethite along with rare earth minerals exist in the rare earth tailings, which is converted to NaFeO₂ after NaOH treatment and then converted to amorphous gel-like iron hydroxide while discharging NaOH during the washing step. Accordingly, the number of washing step increases until the pH of the washing water reaches neutrality, and the time required for solid-liquid separation increases significantly due to the gel-like iron hydroxide (for treating 20 g of sample, 10 times or more washing steps required when washing with 2 L of deionized water).

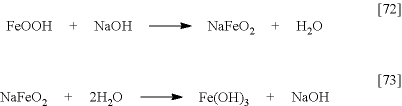

In addition, the formed Fe(OH)₃ is soluble in ethylene glycol (EG)-maleic acid (MA), unlike Fe₃O₄ or Fe₂O₃, and has a higher leaching efficiency than Fe₂O₃ even after roasted, and inhibits the selectivity of rare earth elements.

In the case of monazite concentrates that do not contain FeOOH, NaOH treatment is very effective, but due to the characteristics of rare earth tailings containing a large amount of FeOOH, problems different from the treatment of rare earth concentrates arise.

The fundamental reason why FeOOH is converted to Fe(OH)₃ after NaOH digestion is because Fe exists as trivalent. In the case of NdFeB permanent magnets that use the same pretreatment process, since Fe exists as metallic iron, it is converted to Fe₃O₄ after digestion.

Therefore, it is necessary to develop an effective pretreatment process that can selectively leach rare earth elements from rare earth tailings.

If Fe₃O₄ is obtained as a final product by reducing FeOOH during the NaOH digestion process by adding a reducing agent, it may suppress the formation of Fe(OH)₃, so that it not only reduces the time required for the washing step after the digestion, but also lowers the leaching efficiency of Fe, thereby increasing the selectivity of rare earth elements.

In order to reduce FeOOH in the rare earth tailings, metals such as Mg, Fe, Al, etc., or chemical species containing them, which have a lower standard reduction potential of FeOOH (Eo=0.95 V), may be used as reducing agents. In the following Experimental Examples, metallic Fe and NdFeB permanent magnet powder, which consist of elements contained in the rare earth tailings, were used as reducing agents.

### Experimental Example 3—Use of Fe as a Reducing Agent

The Fe metal powder used as a reducing agent was mixed with the tailings at a mass ratio of 1:1, added to a 50% NaOH solution at a solid-liquid ratio of 1:10 (w/v), and then digested at 145° C. for 5 hours.

The chemical equation of the reaction between FeOOH in the rare earth tailings and Fe metal powder to reduce to Fe₃O₄ is as follows:

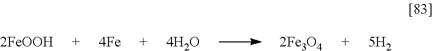

Unlike the ochreous color of the tailing sample without the reducing agent, the sample with the reducing agent added turned black after the digestion, meaning that FeOOH was successfully reduced to Fe₃O₄.

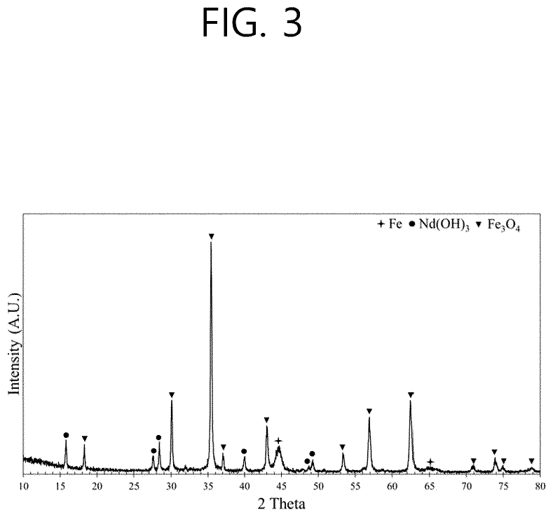

However, the formation of iron hydroxide was observed during the washing process, and as a result of XRD pattern analysis as shown in FIG. 3, it was confirmed that Fe used as a reducing agent remained. Fe remaining after the digestion may cause the iron leaching efficiency to increase and the selectivity of rare earth elements to decrease.

### Experimental Example 4—Use of NdFeB Permanent Magnet Powder as a Reducing Agent

NdFeB permanent magnet powder was used as a reducing agent. NdFeB permanent magnet is considered to be an effective reducing agent since Nd and Fe are oxidized to Nd(OH)₃ and Fe₃O₄, respectively, during the NaOH digestion process, and discharge hydrogen gas.

The chemical equation by which FeOOH in the rare earth tailings and NdFeB magnet powder is reacted to be reduced to Fe₃O₄ is as follows:

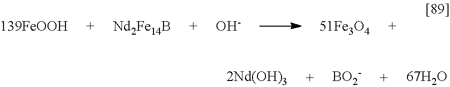

From the chemical equation above, NdFeB was added depending on the chemical equivalent amount and digested (1 equivalent of NdFeB for the content of goethite in 1 g of tailings=0.051 g).

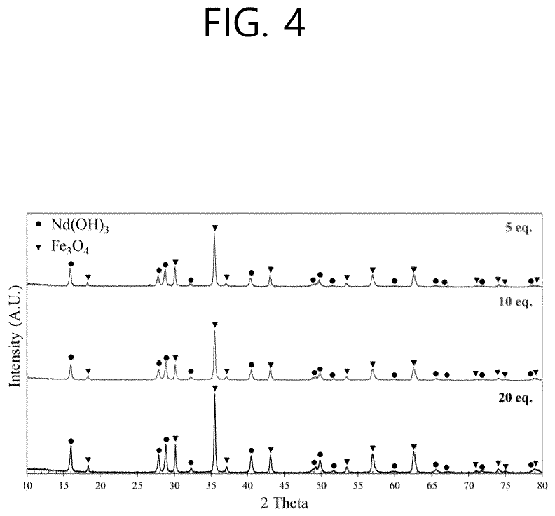

The XRD patterns after the digestion are as shown in FIG. 4, goethite was successfully reduced to Fe₃O₄, and the formation of iron hydroxide was also not observed during the washing process.

In addition, as the amounts of NdFeB addition, a reducing agent, increased, the colors of the final products after the digestion became more blackish, indicating that NdFeB is effective as a reducing agent for reducing FeOOH.

The reductive digested product was added to EG-MA DES at a solid-liquid ratio of 5:100 (w/w) and leached at 70° C. for 5 hours.

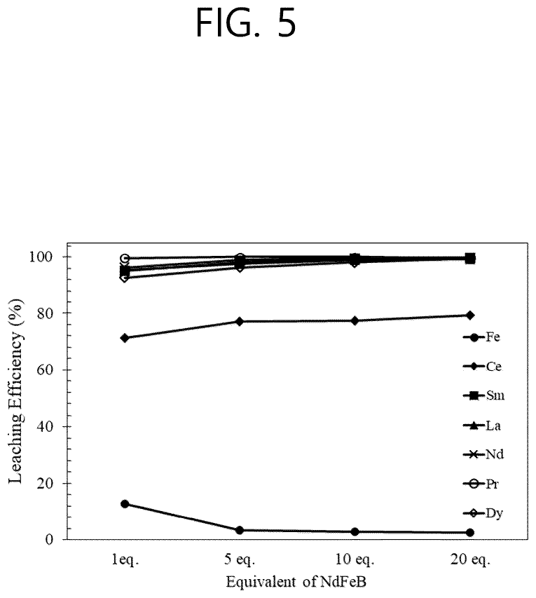

The leaching results of the reductive digested products showed that the iron leaching efficiency was effectively reduced and selective leaching of rare earth elements was possible. As shown in FIG. 5 and Table 5, relatively high iron leaching efficiency were shown at 1 equivalent, but at 5 equivalents or more, about 3% of iron was leached.

The leaching efficiency of rare earth elements also increased significantly, and at 5 equivalents or more, the leaching efficiency of rare earth elements did not increase significantly even when the equivalent ratios increased.

TABLE 5

| | Fe (%) | Ce (%) | Sm (%) | La (%) | Nd (%) | Pr (%) | Dy (%) |
|---|---|---|---|---|---|---|---|
| 1 | 12.3 | 71.3 | 95 | 95.2 | 96.3 | 99.6 | 92.6 |
| equivalent | | | | | | | |
| 5 | 3.4 | 77 | 98.1 | 97.5 | 99 | 100 | 96.2 |
| equivalents | | | | | | | |
| 10 | 2.7 | 77.5 | 99.4 | 98.9 | 99.6 | 100 | 98 |
| equivalents | | | | | | | |
| 20 | 2.6 | 79.2 | 99.6 | 99.3 | 99.7 | 99.6 | 99 |
| equivalents | | | | | | | |

The transition to clean energy is accelerated worldwide to achieve carbon neutrality, and the demand for critical minerals is also increasing accordingly. Rare earth elements are one of the critical minerals, and their demand is expected to increase rapidly in traction motors of electric vehicles and wind turbines.

Since it will be difficult to meet all the rare earth elements demand from primary resources, it is necessary to develop a process for recovering rare earth elements from secondary resources.

In order to recover rare earth elements from monazite, where rare earth elements exist as rare earth phosphates, a pretreatment process for converting rare earth phosphates, which are insoluble in acid, to a form easy to leach should be preceded. Since DESs that are eco-friendly solvents have unique leaching characteristics for metal oxides depending on their type, rare earth elements may be selectively leached using DESs in which iron oxides are insoluble.

As a leaching solvent, ethylene glycol-maleic acid DES, which have excellent light rare earth leaching performance and in which iron oxides are insoluble, may be used.

In the case of tailings containing 10% or more of goethite unlike monazite concentrates with low iron oxide contents, since goethite is converted to trivalent iron hydroxide (Fe(OH)₃) during the pretreatment process using NaOH, selective leaching of rare earth elements is inhibited, and reduction to divalent iron during the pretreatment process is necessary in order to suppress the conversion of trivalent iron of goethite to trivalent iron hydroxide (Fe(OH)₃) during the NaOH digestion.

In Experimental Example 4 of the present disclosure, NdFeB permanent magnet scrap powder was used as a reducing agent, and goethite in rare earth tailings could be converted to magnetite (Fe₃O₄) which is insoluble in an ethylene glycol-maleic acid DES.

As a result of leaching a reductive digested product using NdFeB permanent magnet as a reducing agent at 70° C. for 5 hours using an ethylene glycol-maleic acid DES, when 5 equivalents or more of NdFeB permanent magnet were added, about 3% of iron was leached, La, Nd, Pr, and Dy showed 96% or more of leaching efficiency, Ce showed a leaching efficiency of about 71% or more, and selective leaching of rare earth elements was possible.

Through reductive digestion to which NdFeB permanent magnet was added as a reducing agent in order to selectively recover rare earth elements from rare earth tailings where goethite and monazite coexist, rare earth phosphates were converted to rare earth hydroxides and goethite was reduced to magnetite at the same time, and rare earth elements could be selectively leached using a DES as a leaching solvent.

1. A method for recovering rare earth elements from rare earth raw materials, the method comprising steps of:
alkali-treating a mixture of a reducing agent including a reductive metal having a lower standard reduction potential than goethite and the rare earth raw materials; and
leaching the rare earth elements from the alkali-treated mixture using a deep eutectic solvent, wherein the rare earth raw materials include 10% by weight or more of goethite.

2. The method of claim 1, wherein the rare earth raw materials include rare earth tailings, wherein, in the rare earth tailings, the rare earth elements are contained in a phosphate mineral, and at least a portion of the phosphate mineral is subjected to dephosphorylation by the alkali treatment.

3. The method of claim 1, wherein the phosphate mineral includes at least one of monazite and florencite, and at least a portion of goethite is reduced by the alkali treatment.

4. The method of claim 3, wherein the alkali treatment is performed in a wet manner, and the leaching is performed on a digested material obtained by the alkali treatment.

5. The method of claim 4, wherein the reductive metal includes at least one of magnesium, iron, and aluminum, and the reducing agent is used in an amount of 1 to 20 equivalents based on the content of goethite in the rare earth tailings.

6. The method of claim 5, wherein the reducing agent includes a permanent magnet powder.

7. The method of claim 6, wherein the reducing agent includes a NdFeB permanent magnet powder, and the reducing agent is used in an amount of 3 to 10 equivalents based on the content of goethite in the rare earth tailings.

8. The method of claim 1, wherein the rare earth element may include one of cerium, samarium, lanthanum, neodymium, praseodymium, and dysprosium.

9. The method of claim 8, wherein the alkali treatment is performed using NaOH.

10. The method of claim 8, wherein the deep eutectic solvent is a deep eutectic solvent of ethylene glycol and maleic acid.

11. The method of claim 10, wherein in the rare earth tailings, total rare earth oxides are contained in an amount of 5 to 20% by weight and goethite is contained in an amount of 30 to 80% by weight, the alkali treatment is performed at 100 to 160° C. for 1 to 10 hours at a solid-liquid ratio of 1:5 to 1:20 (w/v) using a NaOH aqueous solution having a concentration of 20 to 70% or 40 to 60%,
the leaching is performed at 50 to 85° C. for 1 to 24 hours at a solid-liquid ratio of 1:100 to 50:100 (w/w),
and the reducing agent is used in an amount of 5 to 7 equivalents based on the content of goethite in the rare earth tailings.
